(19) United States
(12) Patent Application Publication
(10) Pub. No.: US 2001/0030988 A1
(43) Pub. Date: Oct. 18, 2001

(54) Spread spectrum, frequency hopping transceiver with frequency discriminator quadrature filter

(76) Inventor: Terry L. Fry, Davidsonville, MD (US)

Correspondence Address: J. Andrew McKinney, Jr., Adelberg, Rudow, Dorf, Hendler & Sameth, LLC, 600 Mercantile Bank & Trust Bldg., 2 Hopkins Plaza, Baltimore, MD, 21201-2927, US

(21) Appl. No.: 09/752,389

(22) Filed: Dec. 29, 2000

Related U.S. Application Data
(60) Provisional application No. 60/193,932, filed on Mar. 31, 2000.

(51) Int. Cl. H04B 1/713

(52) U.S. Cl. 375/132

(57) ABSTRACT

An economical, compact frequency hopping spread spectrum wireless data telemetry transceiver is adapted to establish and maintain communication links at 2.4 GHz. The wireless transceiver includes RF and computer control components in a compact package approximately the size of a deck of cards and is adapted to be built into original equipment manufacturer (OEM) products to support a wide range of wireless data telemetry applications. Each transceiver includes a shielded RF board or module with a frequency hopping transmitter and receiver, an antenna, and a digital control board or module. The transceiver functions as a half duplex, bi-directional communication device; transmit and receive functions are time interleaved in a non-overlapping fashion. The RF Board consists of a transmitter, receiver, frequency synthesizer and T/R Switch, each controlled by an external microprocessor to either transmit serial data or receive serial data. The receiver includes a novel frequency discriminator quadrature filter including a surface mounted, low power, FM IF system integrated circuit, to provide a minimum shift keying MSK demodulator with a tunable, relatively broad band IF stage in place of the traditional LC tank circuit.

### RELATED APPLICATION INFORMATION

The instant non-provisional patent application claims benefit of co-pending provisional patent application number 60/193,932, entitled Frequency Discriminator Quadrature Filter and filed Mar. 31, 2000, the entire disclosure of which is incorporated herein by reference.

### BACKGROUND OF THE INVENTION

1. Field of the Invention:

The present invention relates to collection of digital data utilizing spread spectrum frequency hopping transceivers, and, more particularly, to transceivers including Frequency Modulation (FM) discriminators for use in quadrature demodulators to perform Frequency Shift Key (FSK) signal demodulation.

2. Discussion of the Prior Art

Infrared and radio frequency (RF) data transmission methods are the principal wireless communication technologies described in the prior art. Infrared beam communications systems cannot operate over distances of more than a few feet and so are limited to applications such as bar code scanning and television (or other home appliance) remote control.

As a result, most of the prior art wireless data transmission products utilize standard RF technology, i.e., radios, the same technology used in vehicle dispatch and police communication systems. Standard RF products are relatively simple and inexpensive to build, but for operation FCC licenses may be required. RF transmissions are susceptible to interference from a growing number of sources and to interception by readily available eavesdropping equipment. The unreliable quality of standard RF transmissions makes the technology unsuitable for applications where all of the information transmitted must be accurate, complete, and secure.

In order to overcome the shortcomings of standard RF transmission methods, direct sequence spread spectrum (DSSS) was developed. DSSS radios divide or slice transmissions into small bits, thereby spreading energy from the bits simultaneously across a wide spectrum of radio frequencies. DSSS is a relatively unreliable transmission medium, however, because spreading the message across a wide spectrum greatly reduces the strength of the radio signal carrying the message on any one frequency. Since a DSSS receiver must simultaneously monitor the entire allotted spectrum, severe interference from a high energy RF source within the monitored spectrum can pose an insurmountable problem. DSSS performance also degrades quickly in shared-service environments having multiple radio systems operating simultaneously.

Frequency hopping spread spectrum (FHSS) technology was developed by the U.S. military to prevent interference with or interception of radio transmissions on the battle field and is employed by the military in situations where reliability and speed are critical. Standard RF and DSSS cannot match the reliability and security provided by frequency hopping. Instead of spreading (and therefore diluting) the signal carrying each bit across an allotted spectrum, as in DSSS, frequency hopping radios concentrate full power into a very narrow spectral width and randomly hop from one frequency to another in a sequence within a defined band, up to several hundred times per second. Each FHSS transmitter and receiver coordinate the hopping sequence by means of an algorithm exchanged and updated by both transmitter and receiver on every hop. Upon encountering interference on a particular frequency, the transmitter and receiver retain the affected data, randomly hop to another point in the spectrum and then continue the transmission. There should always be frequencies somewhere in the spectrum that are free of interference, since neither benign producers of interference or hostile jammers will likely interfere with all frequencies simultaneously and at high power radiation levels, and so the frequency hopping transmitter and receiver will find frequencies with no interference and complete the transmission. This ability to avoid interference enables FHSS radios to perform more reliably over longer ranges than standard RF or DSSS radios. In the prior art, frequency hopping FHSS communication systems have been used almost exclusively in the extremely expensive robust military or government communication systems.

Generally speaking, data telemetry is the transmission of short packets of information from equipment or sensors to a recorder or central control unit. The data packets are transferred as electric signals via wire, infrared or RF technologies and data is received at a central control unit such as a computer with software for automatically polling and controlling the remote devices. The control unit analyzes, aggregates, archives and distributes the collected data packets to other locations, as desired, via a local area network (LAN) and/or a wide area network (WAN). Wireless data telemetry provides several advantages over data telemetry on wired networks. First, wireless systems are easier and less expensive to install; second, maintenance costs are lower; third, operations can be reconfigured or relocated very quickly without consideration for rerunning wires, and fourth, wireless telemetry offers improved mobility during use.

Not just any wireless telemetry system will do for many applications, however. The realities of the marketplace dictate that data telemetry cannot be the most expensive part of a system having commercial application. For example, if a retail point-of-sale cash register is to be configured with a wireless data telemetry radio; the radio cannot be more expensive than the cash register. In many commercial applications, buyers have fixed expectations for what things cost and new features, however useful, cannot substantially exceed those expectations. Thus, it would be best if the wireless data telemetry radio were free. In the interest of providing the most economical wireless data telemetry radio, an MSK transceiver is suggested, but how is the goal of delivering a system with truly useful receiver sensitivity to be accomplished? Spec. designed or off-the-shelf receiver sections are expensive, can have a high parts count, and often require excessive energy, when configured for use in a wireless data telemetry radio. It is desirable to have a wireless data telemetry radio be small, light, resistant to interference from adjacent RF noise sources, and use as little energy as possible.

The Federal Communications Commission (FCC) has designated three license-free bandwidth segments of the radio frequency spectrum and made them available for industrial, scientific and medical (ISM) use in the United States. These three segments are 900 MHZ, 2.4 GHz and 5.8 GHz. Anyone may operate a wireless network in a license-free band without site licenses or carrier fees and is subject only to a radiated power restriction (i.e., a maximum of one watt radiated power). The radio signals transmitted must be spread spectrum. Foreign national spectrum regulation organizations and international telecommunications bodies have also agreed to recognize a common license-free ISM frequency at 2.4 GHz, and so a defacto international standard for license-free ISM communications has emerged. The ISM band at 2.4 GHz provides more than twice the bandwidth capacity and is subject to far less congestion and interference than the ISM band at 900 MHZ. Several industrial nations do not permit a license-free ISM band at 900 MHZ and relatively few nations have a license-free ISM band at 5.8 GHZ, but the United States, Europe, Latin America and many Asian countries have adopted an ISM band at 2.4 GHZ.

In accordance with prior art design practices, an economically designed transceiver may include an FSK demodulator having an Intermediate Frequency (IF) section tuned with a standard inductor-capacitor (LC) tank circuit. While this demodulator may be inexpensive, performance is, in many respects, not up to the task of providing usable sensitivity in a frequency hopping, spread spectrum transceiver.

What is needed, then, is an inexpensive, easy to use and robust data telemetry and communication system including an inexpensive transceiver, preferably operating in the common license-free ISM frequency band and providing reliable communications for a variety of users in commercial and industrial environments.

### OBJECTS AND SUMMARY OF THE INVENTION

Accordingly, it is a primary object of the present invention to overcome the above mentioned difficulties by providing an economical, compact frequency hopping spread spectrum wireless data telemetry transceiver is adapted to establish and maintain communication links in the license-free ISM frequency band at 2.4 GHz.

Another object is to provide a demodulator that is relatively inexpensive, and yet is up to the task of providing usable sensitivity in a frequency hopping, spread spectrum transceiver.

Yet another object of the present invention is to implement a demodulator of usable sensitivity with the smallest possible parts count.

The aforesaid objects are achieved individually and in combination, and it is not intended that the present invention be construed as requiring two or more of the objects to be combined unless expressly required by the claims attached hereto.

In accordance with the present invention, an economical, compact frequency hopping spread spectrum wireless data telemetry transceiver is adapted to establish and maintain communication links at 2.4 GHZ in the license-free ISM frequency band and provides the optimum balance between data rate and range, providing 9.6 kilobits per second (9.6 Kbps) data transmission over an outdoor line of sight range of approximately 35 thousand meters. The transceiver of the present invention includes a novel frequency discriminator quadrature filter including a surface mounted, low power, FM IF system integrated circuit, to provide a minimum shift keying MSK demodulator with a tunable IF stage in place of the traditional LC tank circuit.

The frequency hopping spread spectrum communication system of the present invention includes components ideally suited to specific wireless data telemetry applications. A long range transceiver is configured as a printed circuit card having an edge connector. The wireless transceiver includes RF and computer control components in a compact package approximately the size of a deck of cards and is adapted to be built into original equipment manufacturer (OEM) products to support a wide range of wireless data telemetry applications. Each long range transceiver includes a shielded RF board or module with a frequency hopping transmitter and receiver (including the demodulator), an antenna, and a digital control board or module. The digital control module performs RF module and application interface management and an application interface is included to communicate with specific OEM products utilizing serial (transistor/transistor logic, TTL) or other standard interfaces. The transceiver operates in the license-free portion of the FCC designated ISM frequency band at 2.4 GHz; the transceiver transmits and receives data at 9.6 Kbps at ranges of up to 1500 feet when used indoors with the integrally housed antenna, or up to 12 miles line of sight when used outdoors with an optional directional antenna. The transceiver transmits or receives on any of 550 independent, non-interfering frequencies. When using the transceiver, a data telemetry network can readily be configured for either point-to-point (e.g. wire replacement) or host-to-multipoint networks linked to a user's existing computer or to telephone networks via a system gateway. Optionally, up to 5 collocated independent networks may operate simultaneously, and data security is provided by rapid and random frequency changes (i.e., frequency hopping); the transceiver can optionally be used with data encryption software for providing secure, coded transmissions.

Alternatively, a long range connector transceiver can be attached to a computer or other device using a standard serial (RS232) port. The long range connector duplicates the functions of the long range transceiver but is housed in an enclosure having a cord terminated with an RS232 compatible connector. The long range connector can therefore be used with a wide variety of existing products such as cash registers, ATM machines, laptop computers or any other computer controlled device having an RS232 port and capable of utilizing the frequency hopping spread spectrum communication system software described in the attached appendices.

A plurality of optional antennas can be used with either the transceiver or the long range connector. The standard antenna included with either the long range connector or the long range transceiver is an omni-directional antenna having vertical polarization and a spherical radiation pattern, is built into the transceiver or connector housings and does not require an added cable.

The transceiver functions as a half duplex, bi-directional communication device; transmit and receive functions are time interleaved in a non-overlapping fashion, consistent with the requirements of a frequency hopping radio. The transmit interval is restricted to less than 0.4 seconds. In the course of a normal information exchange, a given transmission is generated on a frequency selected from a set of all available hop frequencies. The transmission is limited in duration to the availability of incoming data, and following the transmission, the radio switches to a receive mode and demodulates any incoming data. Once reception is complete, the transmit interval/receive interval cycle is restarted on a new frequency selected from the hop frequency set. Transmit receive cycling continues until all 75 unique frequencies in the set have been used, whereupon the frequency selection process reenters the top of the table and begins reusing the same 75 frequencies.

As alluded to above, transmitted data is directly modulated onto a synthesized carrier by use of minimum shift keying (MSK) modulation. The receiver is a dual conversion super heterodyne, down converting the received signal first to a 315 MHZ intermediate frequency (IF) signal and then down converting a second time to a 10.7 MHZ IF signal. In accordance with the present invention, demodulation is accomplished using a novel frequency discriminator quadrature filter and limiter/discriminator circuit and the demodulated data is recovered from the demodulator output by processing through a comparator. First and second local oscillators (LOs) are controlled in frequency by use of a single loop indirect frequency synthesis. Samples of both first and second voltage controlled oscillators (VCOs) are divided down using phase-locked loop integrated circuit elements, where each sample is compared to an onboard 8 MHZ crystal reference oscillator. During the transmit interval, a single transmitter VCO is controlled by the same device and in the same manner.

To minimize total power consumption within the transceiver, portions of circuitry not in use during either the transmit or receive intervals are disabled under control of the system controller.

The RF Board consists of transmitter, receiver, frequency synthesizer and T/R switch sections. Each of these sections is controlled by an external microprocessor to either transmit serial data or receive serial data. The basic transmitted signal is generated by a voltage-controlled-oscillator (VCO) that operates in the 2.4 to 2.4835 GHZ frequency band. The signal is then amplified by three stages of amplification. All three amplification stages and the VCO are switched ON for transmit and switched OFF for receive. A power amplifier stage provides 26 dBm of output power to drive the antenna. This stage also uses a GaAs RF Power FET and a similar power control circuit. The transmitted signal passes through the T/R switch and a 2.44 GHZ 4-pole bandpass filter to the antenna. Both the T/R switch and the bandpass filter are implemented using strip line on a separate daughter board.

The receiver uses dual conversion with a first IF of 315 MHZ and a second IF of 10.7 MHZ. The received signal from the antenna passes through the same 2.44 GHZ filter the transmitted signal passed through and then passes through the T/R switch to a Low Noise Amplifier (LNA) included as part of a receiver pre-amp stage.

The analog serial data stream is digitized by thresholding the signal using a comparator and a threshold generated from a peak follower. The peak follower follows both the positive and negative peaks of the analog serial data stream and then generates a threshold signal that is half way between the two peaks. The output of the comparator is the digital received signal output to the digital board.

The RF Board includes an I/O Interface which consists of two mechanical connections. Most of the connections are made via a 20 pin dual in-line header. The other connection is for the antenna and is a microstrip pad and ground connection to which the coaxial antenna cable is soldered. TTL-compatible input signals on the Rx/Tx- pin are used to control the T/R switch. A logic high on this pin puts the T/R switch in the receive position and a logic low puts it in the transmit position. Before the radio switches from receive mode (Rx) to transmit mode (Tx), the T/R switch should be put in the Tx position. When switching from Tx to Rx the T/R switch should remain in the Tx position until after the radio is switched from Tx to Rx.

The RF Board includes an RF I/O connection. When data is presented to the serial port of the digital board, firmware on the digital board will cause the radio to hop on 75 frequencies in the 2400-2483.5 MHz band. The dwell time for each hop is 31.6 ms. During a single hop, the carrier is frequency modulated with the transmit serial data stream from the digital board. Immediately after the transmit time period, the transceiver switches to the receive mode.

The above and still further objects, features and advantages of the present invention will become apparent upon consideration of the following detailed description of a specific embodiment thereof, particularly when taken in conjunction with the accompanying drawings, wherein like reference numerals in the various figures are utilized to designate like components.

### BRIEF DESCRIPTION OF THE DRAWINGS

FIG. 1 is a block diagram of a frequency hopping spread spectrum transceiver, in accordance with the present invention.

FIG. 2 is a perspective view of the transceiver of FIG. 1, in accordance with the present invention.

FIG. 3 is a perspective view of a long range connector, in accordance with the present invention.

FIG. 4a is a perspective view of an omni-directional antenna adapted for use with the transceiver of FIG. 1, in accordance with the present invention.

FIG. 4b is a perspective view of a larger omni-directional antenna adapted for use with the transceiver of FIG. 1, in accordance with the present invention.

FIG. 4c is a perspective view of a directional antenna adapted for use with the transceiver of FIG. 1, in accordance with the present invention.

FIG. 4d is a perspective view of a high gain directional antenna adapted for use with the transceiver of FIG. 1, in accordance with the present invention.

FIG. 5 is a schematic circuit diagram of the Frequency Discriminator Quadrature Filter, illustrating the signal flow into and through the surface mounted, low power, FM IF system integrated circuit, in accordance with the present invention.

FIG. 6a is a block diagram of the Frequency Discriminator Quadrature Filter surface mounted, low power, FM IF system integrated circuit of FIG. 5, in accordance with the present invention.

FIG. 6b is a pin configuration diagram of the Frequency Discriminator Quadrature Filter including a surface mounted, low power, FM IF system integrated circuit of FIG. 5, in accordance with the present invention.

FIG. 7 is a schematic diagram of the Frequency Discriminator Quadrature Filter of FIG. 5, illustrating the signal flow into and through the surface mounted, low power, FM IF system integrated circuit, in accordance with the present invention.

### DETAILED DESCRIPTION OF THE PREFERRED EMBODIMENTS

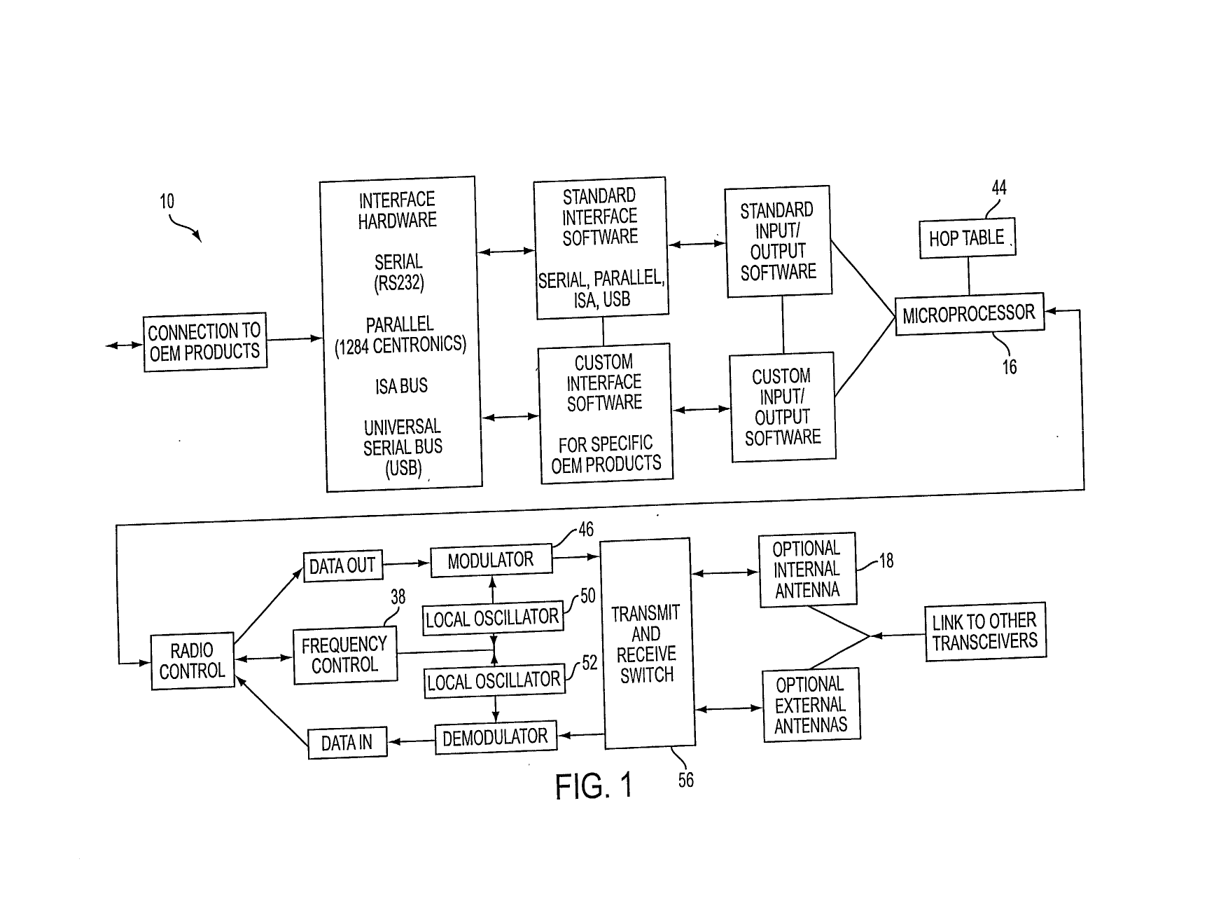

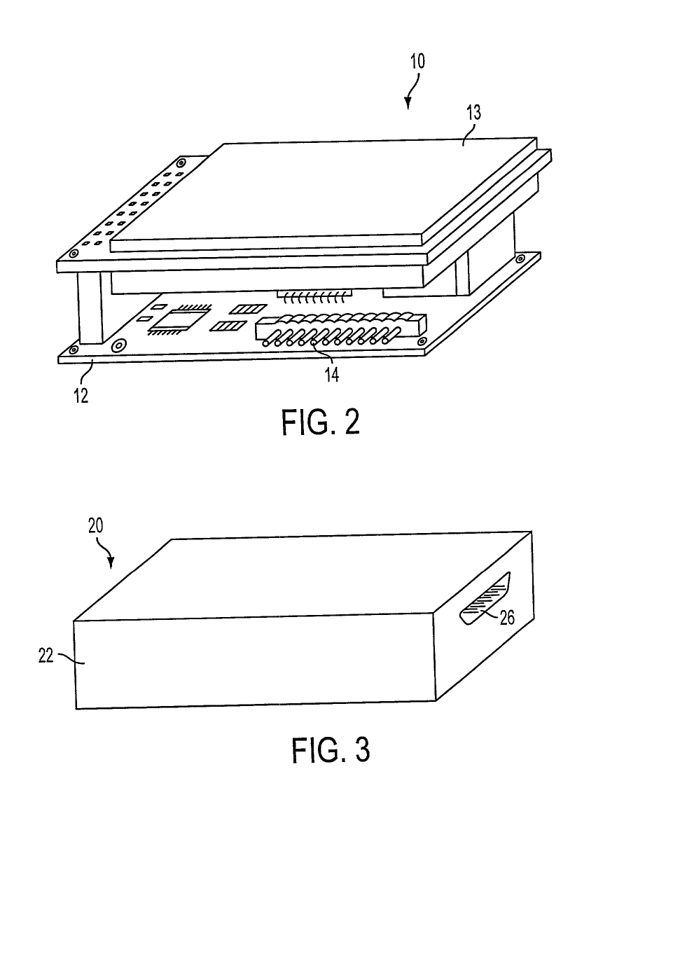

In accordance with the present invention, a frequency hopping, spread spectrum communication transceiver 10 is adapted to dynamically establish and maintain communication links between two or more transceivers and includes components ideally suited to wireless data telemetry applications. As shown in FIGS. 1 and 2, transceiver 10 is configured as a stacked pair of printed circuit cards including a digital board 12 connected to a shielded RF board 13, the digital board carries a multi-pin connector 14. Transceiver 10 includes RF and computer control components in a compact package approximately the size of a deck of cards and is adapted to be built into original equipment manufacturer (OEM) products to support a wide range of wireless data telemetry applications. Shielded RF board 12 includes a frequency hopping transmitter and receiver, as well as an antenna. The digital control module micro processing unit (MPU) 16 performs RF module and application interface management and an application interface is included to communicate with specific OEM products utilizing serial (transistor/transistor logic, TTL) or other standard interfaces. Transceiver 10 operates in the license-free portion of the FCC designated ISM frequency band at 2.4 GHZ, transmitting and receiving data at 9.6 Kbps at ranges of up to 1500 feet when used indoors with the integrally housed antenna 18, or up to 12 miles line of sight when used outdoors with an optional directional antenna. Transceiver 10 transmits or receives on any of 550 independent, non-interfering frequencies. When using transceiver 10, a data telemetry network can readily be configured for either point-to-point (e.g. wire replacement) or host-to-multipoint networks linked to a user's existing computer or to telephone networks via a system gateway. Optionally, up to 5 collocated independent networks may operate simultaneously, and data security is provided by rapid and random frequency changes (i.e., frequency hopping); transceiver 10 can optionally be used with data encryption software for providing secure, coded transmissions.

To Alternatively, a long range connector transceiver 20 as shown in FIG. 3 can be attached to a computer or other device using a standard serial (RS232) port. The long range connector 20 duplicates the functions of the long range transceiver of FIGS. 1 and 2 but is housed in an enclosure 22 having an RS232 compatible connector 26. The long range connector 20 can therefore be used with a wide variety of existing products such as cash registers, ATM machines, laptop computers or any other computer controlled device having an RS232 port and capable of utilizing a frequency hopping spread spectrum communication system software package used to configure a user's or vendor's particular system.

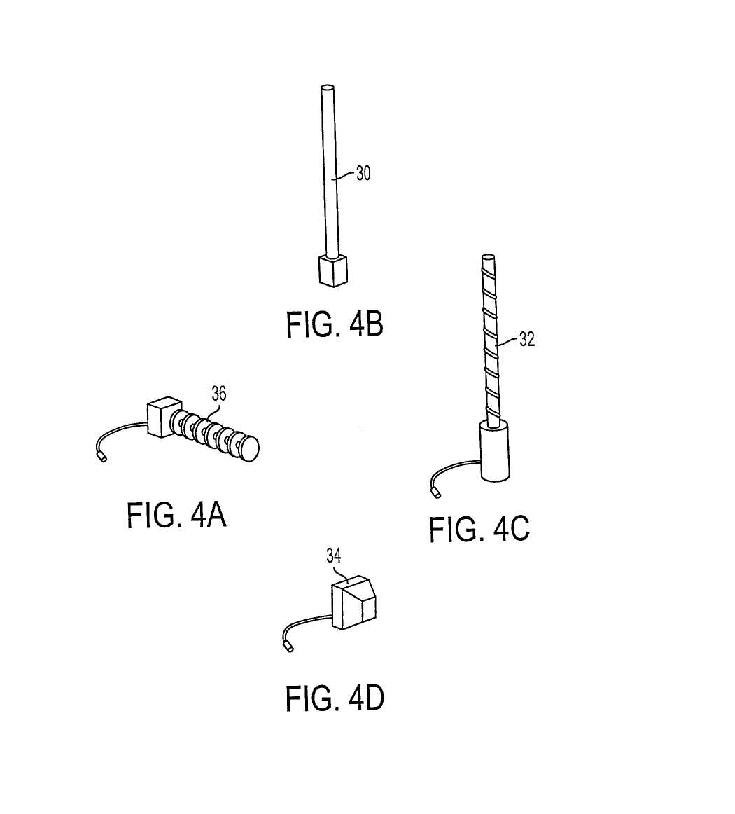

As best seen in FIGS. 4a-4d, a plurality of optional antennas can be used with either transceiver 10 of FIG. 2 or the long range connector 20 of FIG. 3. In particular, the four inch high mast antenna 30 of FIG. 4b provides moderately enhanced performance and an omnidirectional pattern; the 28 inch high phased array antenna 32 of FIG. 4c provides substantially improved performance in all horizontal directions. The 6 inch flat square panel antenna 34 of FIG. 4d provides substantially improved performance in a single direction, and the 30 inch long tube antenna 36 of FIG. 4a provides dramatically improved performance in a single direction by providing a highly directional beam width. The standard antenna 18 included with either the long range connector 20 of FIG. 3 or the long range transceiver 10 of FIG. 2 is an omni-directional antenna having vertical polarization and a spherical radiation pattern. Standard antenna 18 is built into transceiver 10 or connector housing 22 and does not require an added cable. The four optional antennas of FIGS. 4a-4d are adapted to be connected using selected cable links or connectors, as required for a specific application.

Transceiver 10 functions as a half duplex, bi-directional communication device over the air. The transmit and receive functions are time interleaved in a non-overlapping fashion, consistent with the requirements of a frequency hopping radio. The transmit interval is restricted to less than 0.4 seconds on any particular frequency within a thirty second interval. In the course of a normal information exchange, a given transmission is generated on a frequency selected from a set of all available hop frequencies stored in hop table 44. The transmission is limited in duration to the availability of incoming data (or the data payload size for that frame) and following the transmission, the radio switches to a receive mode and processes any incoming data. Once reception is complete, the transmit interval/receive interval cycle is restarted on a new frequency selected from the hop frequency set. Transmit receive cycling continues until all 75 unique frequencies in the set have been used, whereupon the frequency selection process reenters the top of the hop table and begins reusing the same 75 frequencies.

Transmitted data is directly modulated using modulator 46 onto a synthesized carrier by use of minimum shift keying (MSK) modulation. The receiver is a dual conversion super heterodyne, down converting the received signal first to a 315 MHZ intermediate frequency (IF) signal and then down converting a second time to a 10.7 MHZ IF signal. Demodulation is accomplished using a limiter/discriminator circuit and the demodulated data is recovered from the demodulator output by processing through a comparator. First and second local oscillators (LOs) 50, 52 are controlled in frequency by frequency control circuit 38 which performs a single loop indirect frequency synthesis. Samples of both first and second voltage controlled local oscillators (VCOs) 50, 52 are divided down using phase-locked loop integrated circuit elements, where each sample is compared to an onboard 8 MHZ crystal reference oscillator. During the transmit interval, a single transmitter VCO is controlled by the same device and in the same manner.

To minimize total power consumption within the transceiver, portions of circuitry not in use during either the transmit or receive intervals are disabled under control of the system controller 16.

Frequency management is accomplished by a method incorporated in the transceiver control software. The transceiver initially powers up in an “idle slave” mode and operates in receive mode only, stepping through all 75 hop frequencies while “listening” for an incoming header packet matching the idle slave's local address.

When data is presented to a transceiver via its local communications port (e.g., RS-232), the transceiver immediately shifts from idle slave mode to a “master search” mode wherein the master transmits and then listens for (receives) an acknowledgment signal from a targeted remote slave device (i.e., a transceiver in idle slave mode). The transmit and receive periods each represent one-half of a complete hop interval. The master continues to search for the slave device until a valid acknowledgment is received or until a predetermined time-out period expires. The initiation of master search mode starts at whichever hop frequency the transceiver was previously using while in idle slave mode and continues to step through the hop table selecting frequencies in turn. Since the incoming data is a synchronous in nature, the master transceiver essentially begins this process at a random point within the hop table.

An idle slave device, after receiving a valid header data packet, transmits an acknowledgment packet during the master's listening phase of the hop interval, thereby creating a synchronized and linked session for data transfer. Once linked, the master and slave transceivers increment through all 75 entries in the hop table for as long as incoming data is present for either unit, after a programmable time-out period. The master transmits during the first half of each hop interval and the slave transmits during the second half of the interval with the slave device adjusting its response time in accordance with the received data packet, thereby maintaining synchronization between both master and slave devices. When neither master nor slave has any additional data to transmit, both units return to the idle slave mode after a preprogrammed time-out period.

The receiver portion of the transceiver is implemented very economically; the recovered analog serial data stream is digitized by thresholding the signal using a comparator and a threshold generated from a peak follower. The peak follower follows both the positive and negative peaks of the analog serial data stream and then generates a threshold signal that is half way between the two peaks. The output of the comparator is the digital received signal directed to digital board 12. A universal asynchronous receiver-transmitter (UART) is incorporated in each transceiver to process both transmit and received data.

Transceivers communicate using an On-Air Protocol that is stored in firmware and includes specific characteristics for the two types of on-air “frames”, i.e., the linking frame and the data frame. The linking frame is transmitted when transceivers are not currently communicating to synchronize them to the same frequency. Once the transceivers are synchronized, data frames are transmitted until the (then) current session ends, even if there is no data to be sent. “Synchronization”, as used here, does not mean that precisely synchronized clocks (i.e., between transceivers) are required, however.

Turning now to a more detailed description of transceiver RF components, RF Board 13 consists of a transmitter, receiver, frequency synthesizer and a transmit/receive (T/R) switch. Each of these sections is controlled by microprocessor 16 to either transmit serial data or receive serial data.

The basic transmitted signal is generated by a voltage-controlled-oscillator (VCO) that operates in the 2.4 to 2.4835 GHZ frequency band. The signal is then amplified by three stages of amplification. All three amplification stages and the VCO are switched ON for transmit and switched OFF for receive.

The first stage of amplification is provided by a bipolar transistor capable of generating at least 10 dBm output power to boost the signal generated by the VCO and drive the exciter stage and to provide some isolation between the power stages and the VCO. The base bias on both the VCO and bipolar amplifier is controlled to provide the transmit ON/OFF function.

The exciter stage boosts the power to at least 22 dBm to drive the power amplifier stage. The is accomplished using a GaAs RF Power FET. A power control circuit is used to generate the gate bias voltage. The circuit is a closed loop control circuit that controls the level of drain current. Different drain current settings are used to control the output power of the amplifier. This includes the OFF state for receive as well as three other power levels. The power level settings are programmed via two control lines accessible at the RF Board connector. The circuit also controls the turn-on and turn-off times so that spectral splatter can be reduced.

The power amplifier stage provides 26 dBm of output power to drive the antenna. This stage also uses a GaAs RF Power FET and a similar power control circuit. The same two control lines that control the exciter power level also control the power amplifier power level. The transmitted signal passes through T/R switch 56 and a 2.44 GHZ 4-pole bandpass filter to the antenna. Both T/R switch 56 and the bandpass filter are implemented using strip line on a separate daughter board.

As noted above, the receiver uses dual conversion super heterodyne configuration with a first IF of 315 MHZ and a second IF of 10.7 MHZ. The received signal from the antenna passes through the same 2.44 GHZ filter the transmitted signal passed through and then passes through the T/R switch to a low noise amplifier (LNA). The filter acts as a preselector to prevent strong out-of-band signals from desensitizing the receiver. The LNA provides approximately 15 dB gain with 2 dB noise figure. An image rejection filter centered on 2.44 GHZ follows the LNA, and is implemented as a strip-line 2-pole bandpass interdigital filter on a separate daughter board.

The first heterodyne mixer is after the image filter. The local oscillator (LO) for the first mixer is a 2.085 to 2.1685 GHZ VCO which is part of the synthesizer. At each hop frequency, the first LO is tuned to a frequency 315 MHZ below the receive frequency. The LO signal passes through the LO filter to the first mixer. This filter is also implemented on the daughter board using strip line and is a 2-pole bandpass interdigital filter centered at 2.125 GHZ. The output of the mixer consists of a number of signals, one of which corresponds to the first IF of 315 MHZ. A 315 MHZ surface acoustic wave (SAW) filter follows the mixer to select the first IF from amongst the products of the mixer.

Following the SAW filter is a stage of 315 MHZ amplification.

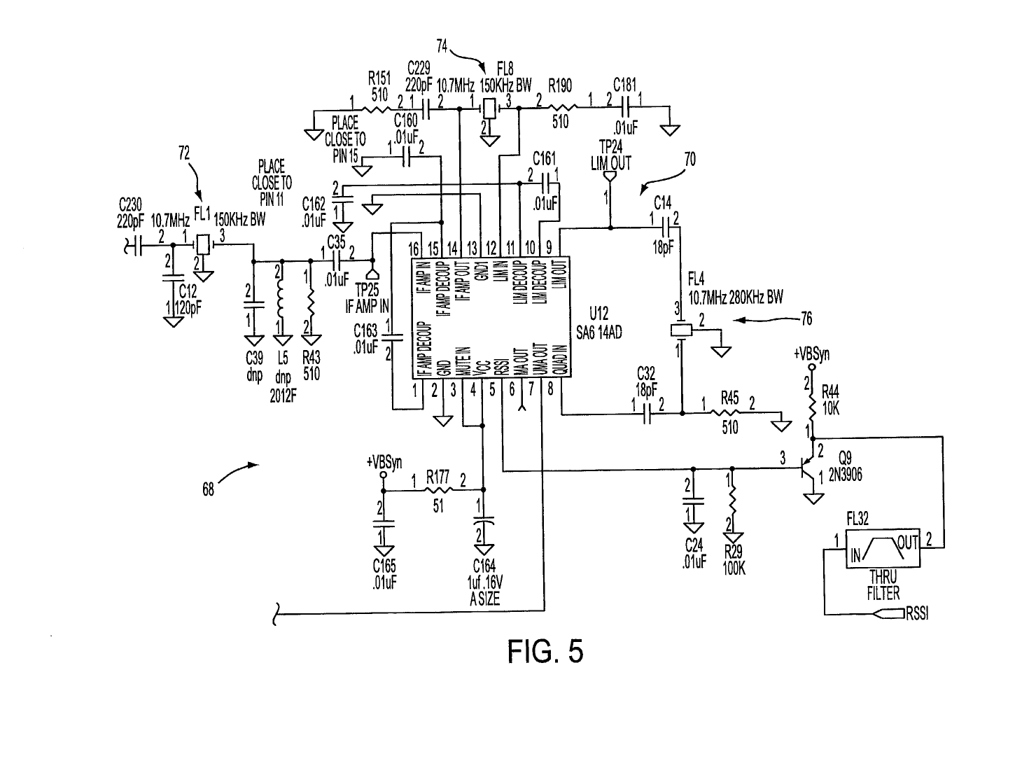

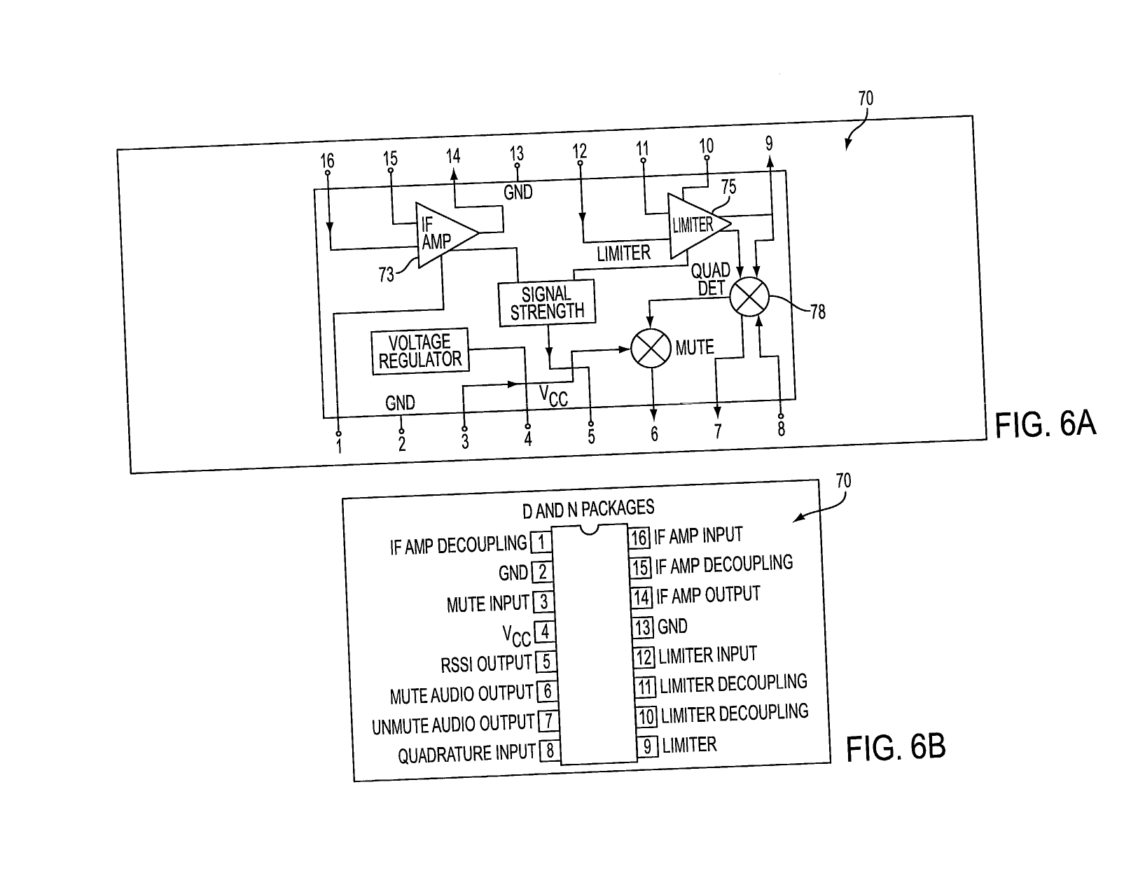

The signal then passes to the second heterodyne mixer. The second mixer uses a high side LO frequency of 325.7 MHZ so that mixing products are not generated on other channels in the 2.4 to 2.4835 GHZ frequency band. The desired result of this mixer is a 10.7 MHZ signal which then passes through a 10.7 MHZ ceramic 150 KHz bandpass filter to an IF amplifier. The signal passes through another 10.7 MHZ ceramic 150 KHz bandpass filter after the IF amplifier and then to the limiter amplifier. Both of these amplifiers and the active part of the discriminator or frequency discriminator quadrature filter 68 employ an IF processing integrated circuit or chip 70, as best seen in FIGS. 5, 6a and 6b. A third 10.7 MHZ ceramic 400 KHz bandpass filter is used as the delay element in the discriminator 68. Discriminator 68 produces an analog version of the serial data stream.

The analog serial data stream is digitized by thresholding the signal using a comparator and a threshold generated from a peak follower. The peak follower follows both the positive and negative peaks of the analog serial data stream and then generates a threshold signal that is half way between the two peaks. The output of the comparator is the digital received signal output to the digital board 12.

The frequency synthesizer generates the modulated transmit signal, the receiver first LO, and the receiver 2^{nd} LO, each phase locked to the on-board 8 MHZ reference.

The 8 MHZ reference is a crystal oscillator that is controlled by the off-board microprocessor 16. To enable a cost effective solution for the reference an inexpensive crystal is utilized. Because a frequency tolerance of 3 parts per million (ppm) must be maintained for the transceiver to communicate, a frequency compensation routine is programmed for execution with microprocessor 16. The compensation deals with both the initial crystal manufacturing tolerance and maintaining tolerance over the specified −20 to 70 degrees Celsius temperature range.

The transmitted signal is generated by a VCO, switched on during transmit, operating over a 350 MHZ tuning range roughly centered on 2.44 GHZ. During operation the VCO only tunes in the 2.4 to 2.4835 GHZ band. Having a larger tuning range allows for manufacturing tolerances without the need to tune the oscillators for each manufactured board. During operation, the synthesizer chip is programmed to the required hop frequencies. The chip has a fast and a slow loop response time mode. When a frequency is first programmed the chip is placed in the fast mode. After a selected interval of approximately 3 ms the chip is switched to slow mode. This allows the tuning loop time to settle on the correct frequency and then slows the loop response time so that frequency modulation of the transmitted signal by the-data can be accomplished by impressing very small changes on the tuning voltage. If the tuning loop response time were not slowed, then it would be able to partially correct the small tuning voltage impressions and cause pulse droop on the subsequently received signal.

The first LO signal is generated by second LO VCO 52, switched on during receive in the place of the transmit VCO 50. This receive VCO 52 shares the same connections to the synthesizer chip as the transmit VCO 52. As with the transmit VCO, it has a tuning range of 350 MHZ, to allow for manufacturing tolerances. Its tuning range is roughly centered on 2.125 GHZ which is 315 MHZ below the transmit frequencies. During operation, it hops to frequencies in the 2.085 to 2.1685 GHZ band. Unlike the transmit VCO, the synthesizer chip is tuned to a frequency in fast mode and never switched to slow mode. This allows the synthesizer combination to have a much better close-in phase noise.

The second LO signal is generated by a VCO that has approximately a 35 MHZ tuning range centered on 325.7 MHZ. This VCO is connected to the low frequency section of the dual frequency synthesizer chip. This VCO and this section of the synthesizer chip are energized only while receiving. It is always programmed to 325.7 MHZ.

The RF Board l/0 Interface consists of two mechanical connections. Most of the connections are made via a 20 pin dual in-line header. The antenna connection is a microstrip pad and ground to which the coaxial antenna cable is soldered. TTL-compatible input signals on an Rx/Tx- pin are used to control the Rx/Tx switch 56. A logic high on this pin puts the Rx/Tx switch in the receive position and a logic low puts it in the transmit position. Before the radio switches from Rx mode to Tx Mode the Rx/Tx switch 56 should be put in the Tx position. When switching from Tx mode to Rx mode the switch 56 should remain in the Tx position until after the radio is switched from Tx to Rx.

Turning now to a more detailed disclosure of the preferred embodiment, frequency discriminator 68, in accordance with the present invention, is included as part of RF board 13, and preferably includes a Signetics™ Brand NE/SA614A Low Power FM IF system monolithic integrated circuit chip 70, as best seen in FIGS. 5, 6a and 6b. FIG. 5 is a schematic circuit diagram of the frequency discriminator 68, illustrating the signal flow into and through the surface mounted, low power, FM IF system integrated circuit 70; FIG. 6a is a block diagram of integrated circuit 70, and FIG. 6b is a pin configuration diagram of the integrated circuit 70.

In accordance with an important aspect of the present invention, frequency discriminator 68 is, effectively, an implementation of an FM discriminator, as it referred to in the literature, where the “quadrature” is derived, not from conventional LC resonator circuitry, but rather is derived from a fixed, pre-tuned IF filter 76 supplied (by various manufacturers) as an intact, already tuned IF filter to be used for selectivity. Filter 76, in this case, is used to supply the phase shift necessary to operate the quadrature demodulator. Filter 76 is wider in bandwidth than the receiver IF filters 72, 74, for purposes of selectivity, and has a few components around integrated circuit 70 that help correct its phase offset to be near 90 degrees, at the center of the IF, where the demodulation is happening.

In the embodiment illustrated in FIG. 5, a number of prefabricated ceramic filters 72, 74 and 76, shown as FL1, FL8 and FL4, respectively, are available from a variety of companies, (e.g., Murata and Toko). IF Ceramic bandpass filter 72 operates around a center frequency of 10.7 MHz and has a bandwidth of 150 KHz. IF Ceramic bandpass filter 74 also operates around a center frequency of 10.7 MHZ and has a bandwidth of 150 KHz. Frequency discriminator quadrature filter element 76, also operates around a center frequency of 10.7 MHz but is unique in having a bandwidth of 280 KHz. Frequency discriminator quadrature filter 76 is, in this particular implementation, a 280 KHz wide filter in an IF chain having a selected narrower bandwidth, e.g., 150 KHz in bandwidth. Preferably, the bandwidth for frequency discriminator quadrature filter 76 is approximately double the bandwidth of the IF bandpass filters 72 and 74. For example, if IF bandpass filters 72 and 74 have a bandpass width of 150 KHz, then frequency discriminator quadrature Filter 76 is approximately double the bandwidth of the IF bandpass filters 72 and 74 and is set at 280 KHz. If IF bandpass filters 72 and 74 have a bandpass width of 230 KHz, then frequency discriminator quadrature filter 76 is approximately double the bandwidth of the IF bandpass filters 72 and 74 and is set at 400 KHz.

To reiterate, in the embodiment of FIG. 5, 150 KHz is the channel width or the selectivity of the receiver section IF and the 280 KHz band width of the filter is used as a quadrature filter, and so is much wider than the IF bandwidth for purposes of allowing a long, a very wide bandwidth over which the discriminator 68 can work. With this relationship among the IF and quadrature filter bandwidths, discriminator 68 provides a reasonably linear detection range over the entire useable frequency of the IF, and somewhat beyond, so that sharp distortions of the demodulated data within the 150 KHz IF are avoided, owing to the wide bandwidth of the quadrature filter.

The other advantage in the quadrature filter of the illustrated embodiment is that, being a multi-pole filter (as opposed to the single pole or single section resonator, as is more typical in a prior art quadrature filter), a higher Q response and greater recovered video signal are obtained. In the prior art, a single L-C section is most common. In the illustrated embodiment, a two section filter is employed (although any number of sections are possible). The two section filter has a steeper phase versus frequency curve than the single section filter would have, and thereby produces a greater recovered video signal than for a single section. The recovered video voltage peak to peak (or demodulated data in our case) is larger, in terms of raw voltage, owing to the fact that a multi-section filter 76 is used as the quadrature element.

Returning to demodulating MSK, generally, in this application, because digital signals are demodulated (as opposed to voice or some analogue type of demodulation) a frequency discriminator is to be used and the discriminator in this case is seeing a signal of the general FSK type which could be GMSK or MSK or other related modulation schemes. The modulation schemes are differentiated from each other by the bandwidth of the base band signal used to generate the modulation in the first place, and the shaping of that signal (in terms of frequency response). The response of frequency discriminator quadrature filter 68 is as a frequency discriminator, as opposed to a phase demodulator. This is a non-coherent data recovery or demodulation process. The signal in this case appears in the IF as a fairly rapid set of frequency changes, rapid enough to be viewed if we had adjacent bit changes (toggling ones and zeros) as alternating phase shifts. Frequency discriminator 68 does the demodulation. The video signal is recovered by observing the difference in phase of the IF signal being split into two pieces, one of which goes through the multi-pole pre-tuned external filter, the 280 KHz filter in this case. Whereas the second path comes from the limiter that's part of the integrated limiter amplifier 75 used to provide the quadrature demodulation. This other limiter goes into internal mixer 78. The two parts of the mixer being the direct limiter output and then also the limiter output passes through the external former 280 KHz filter. The phase difference between the two paths is adjusted to be approximately 90 degrees at band center, 10.7 megahertz in the exemplary embodiment, and this produces a video output from the mixer that varies monotonically over a selected frequency range, positive voltage in one direction for phase motion in one direction, negative voltage in the other. That positive and negative motion becomes a demodulated data signal. As the phase or frequency in the IF varies due to the modulation that came from the transmitter, which is ultimately being received at this point, those phase and/or frequency changes are displayed in the output of the mixer because of the frequency sensitive phase delay of the 280 kilohertz filter, since the direct path of the limiter is presumed to have no significant phase delay as phase and frequency varies to its destination point in the demodulating mixer 78.

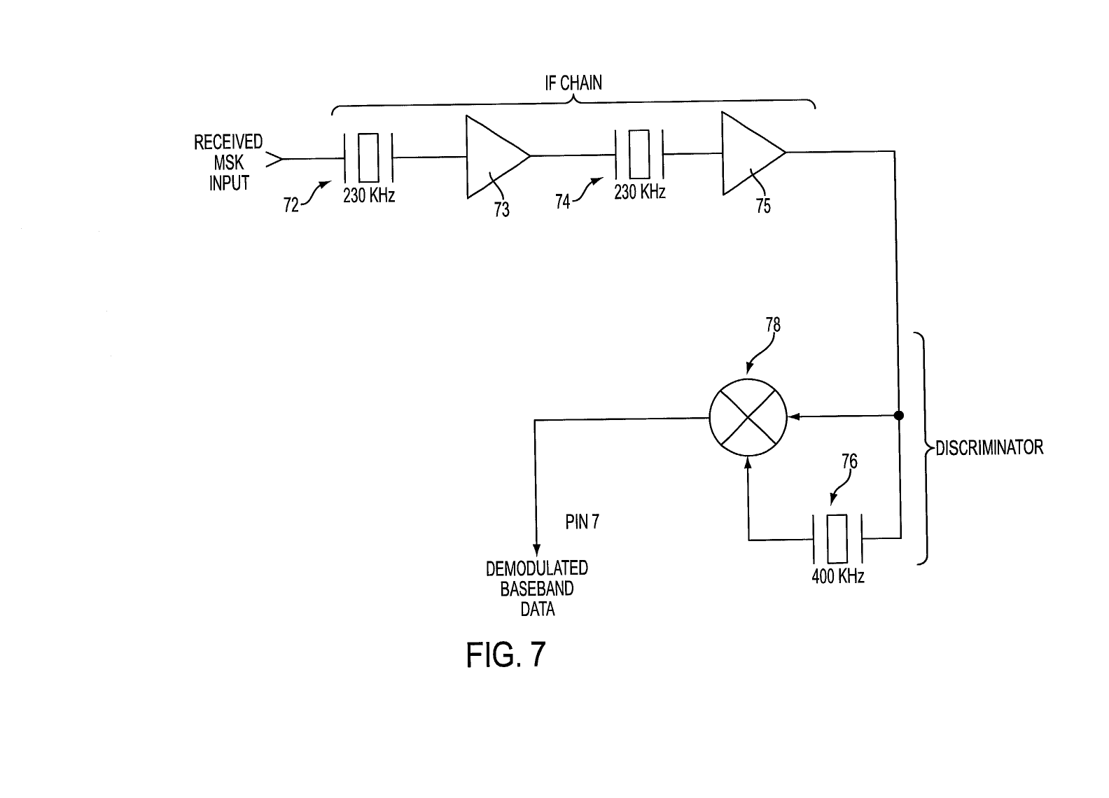

Turning now to FIGS. 5, 6a, 6b and 7, one can follow the signal from node to node. Using the pin numbers on the device (i.e., the NE/SA614A integrated circuit 70 of FIGS. 6a and 6b). The 10.7 megahertz IF signal is introduced to the limiter discriminator chip 70 in pin 16 and goes through the IF Amp 73. The amplified signal is filtered at the IF selectivity filter band width (e.g., either 150 or 230 kilohertz), between pins 14 and 12 with external filter FL8 or 74. The signal path then reenters chip 70 at pin 12, completes its path through the limiter string and through one of the two limiter outputs, exiting the chip on pin 9.

The initial input is to pin 16, there's a certain amount of amplifier gain out to pin 14, and the signal goes through a second external IF (150 or 230 KHz bandwidth) filter 74. After passing through second bandpass filter 74, the signal reenters chip 70 at pin 12, completes its path through limiting amplifier 75 and finally the output signal of the final limiter stage is split into two parts. One part of the limiting amplifier output signal comes out on pin 9 for application to a pre-mixer quadrature filter 76, FL4, in accordance with the present invention. The other part of the limiting amplifier output signal is connected internally, within chip 70, to internal mixer 78 without an external access point.

Mixer 78 is impinged on by the two signal parts. One being the direct internal connection of the output of limiter 75 and the second being the external frequency versus phase control path that goes through pre-mixer quadrature or discriminator filter 76 and reenters the chip on pin 8.

The output signal from mixer 78 is generated from two input signals with different phase but not different frequency, and so the mixer output signal is a baseband DC signal or video signal that varies in synchronization with the modulation impressed on the original received signal passed into the IF. The output of mixer 78 varies because of the phase versus frequency slope of the discriminator filter 76, in accordance with the present invention. Again, filtered signal goes into pin 8 and the video outputs from the mixer are present on both pins 7 and 6. The signal at the Pin 7 output is used in this circuit, but both pin 7 and pin 6 are similar outputs from the demodulating mixer. On pin 7, the demodulated video signal is presented as a baseband data signal.

It will be appreciated that the present invention makes a available a high performance, yet economical, novel frequency discriminator quadrature filter including a surface mounted, low power, FM IF system integrated circuit, to provide a frequency shift keying FSK demodulator with a tunable, relatively broad band, IF stage in place of the traditional LC tank circuit.

In as much as the present invention is subject to various modifications and changes in detail, the above description of a preferred embodiment is intended to be exemplary only and not limiting. It is believed that other modifications, variations and changes will be suggested to those skilled in the art in view of the teachings set forth herein.

I claim:

1. An economical, compact, frequency hopping, spread spectrum, wireless data telemetry transceiver, comprising:
a frequency hopping transmitter;
a frequency hopping receiver;
said receiver including a first bandpass filter tuned to a selected IF center frequency and having a first selected IF bandpass bandwidth, said first bandpass filter generating a first filtered IF signal; said first filtered IF signal including a frequency shift keying modulated waveform;
said receiver further including a frequency discriminator being configured to receive said first filtered IF signal and comprising a limiter amp stage and a quadrature detecting mixer having first and second inputs and an output;
said frequency discriminator receiving said first filtered IF signal frequency shift keying modulated waveform and generating a demodulated baseband video digital data signal in response thereto;
said frequency discriminator further comprising a second bandpass filter tuned to said selected IF center frequency and having a second selected IF bandpass bandwidth, said second bandpass filter being responsive to said first filtered IF signal and generating a second bandpass filter output signal in response thereto;
said limiter amp stage being configured to receive said second bandpass filter output signal and to generate a limiter amp output signal in response thereto;
said frequency discriminator further comprising a third bandpass filter tuned to a selected IF center frequency and having a third selected IF bandpass bandwidth, said third selected IF bandpass bandwidth being greater than said first selected IF bandpass bandwidth and said second selected IF bandpass bandwidth; said third bandpass filter being responsive to said limiter amp output signal and generating a quadrature filtered limiter amp output signal in response thereto;
said limiter amp output signal also being passed to said quadrature detecting mixer first input; said quadrature detecting mixer second input being configured to receive said quadrature filtered limiter amp output signal from said third bandpass filter, said first quadrature detecting mixer generating a demodulated baseband signal in response thereto.

2. The transceiver of claim 1, said frequency shift keying modulated waveform comprising a minimum shift keying waveform.

3. The transceiver of claim 1, said frequency discriminator further comprising an IF amp gain stage configured to receive said first filtered IF signal and generating an amplified first filtered IF signal therefrom.

4. The transceiver of claim 1, said first bandpass filter comprising a prefabricated, pretuned filter.

5. The transceiver of claim 4, said first bandpass filter comprising a prefabricated ceramic filter.

6. The transceiver of claim 1, said second bandpass filter comprising a prefabricated, pre-tuned filter.

7. The transceiver of claim 6, said second bandpass filter comprising a prefabricated ceramic filter.

8. The transceiver of claim 1, said third bandpass filter comprising a prefabricated, pre-tuned filter.

9. The transceiver of claim 8, said third bandpass filter comprising a prefabricated ceramic filter.

10. The transceiver of claim 8, said third bandpass filter comprising a prefabricated ceramic filter having a fixed bandwidth approximately double said first bandpass filter bandwidth.

11. The transceiver of claim 8, said second bandpass filter comprising a prefabricated ceramic filter having a fixed bandwidth substantially equal to said first bandpass filter bandwidth.

12. The transceiver of claim 1, said Limiting amp and said Mixer being integrated into a single integrated circuit.

13. The transceiver of claim 12, said single integrated circuit also including said IF amp gain stage configured to receive said first filtered IF signal.

14. An economical receiver demodulator for demodulating a frequency shift keying (FSK) signal and generating a demodulated baseband video digital data signal in response thereto, comprising;
a first bandpass filter tuned to a selected IF center frequency and having a first selected IF bandpass bandwidth, said first bandpass filter generating a first filtered IF signal;
a frequency discriminator configured to receive said first filtered IF signal and comprising a limiter amp stage and a quadrature detecting mixer having first and second inputs and an output;
said limiter amp stage being responsive to said first bandpass filter output signal and generating a limiter amp output signal in response thereto;
said frequency discriminator further comprising a second bandpass filter tuned to said selected IF center frequency and having a second selected IF bandpass bandwidth, said second selected IF bandpass bandwidth being greater than said first selected IF bandpass bandwidth; said second bandpass filter being responsive to said limiter amp output signal and generating a quadrature filtered limiter amp output signal in response thereto;
said limiter amp output signal also being passed to said quadrature detecting mixer first input; said quadrature detecting mixer second input being configured to receive said quadrature filtered limiter amp output signal from said second bandpass filter, said first quadrature detecting mixer generating a demodulated baseband signal in response thereto.

15. The receiver demodulator of claim 14, said frequency shift keying modulated waveform comprising a minimum shift keying waveform.

16. The receiver demodulator of claim 14, said frequency discriminator quadrature filter further comprising an IF amp gain stage configured to receive said first filtered IF signal and generating an amplified first filtered IF signal therefrom.

17. The receiver demodulator of claim 14, said second bandpass filter comprising a prefabricated, pre-tuned filter.

18. The receiver demodulator of claim 17, said second bandpass filter comprising a prefabricated ceramic filter.

19. The receiver demodulator of claim 18, said second bandpass filter comprising a prefabricated ceramic filter having a fixed bandwidth approximately double said first bandpass filter bandwidth.

20. The receiver demodulator of claim 19, said Limiting amp and said Mixer being integrated into a single integrated circuit.

21. The receiver demodulator of claim 20, said single integrated circuit also including said IF amp gain stage configured to receive said first filtered IF signal.

22. An economical receiver demodulator for demodulating a frequency shift keying (FSK) IF signal at a selected IF center frequency and having a first selected IF bandpass bandwidth, and generating a demodulated baseband video digital data signal in response thereto, comprising;
a frequency discriminator configured to receive said IF signal and comprising a limiter amp stage and a quadrature detecting mixer having first and second inputs and an output;
said frequency discriminator further comprising a quadrature bandpass filter having a selected quadrature filter bandpass bandwidth greater than the IF bandpass bandwidth, said selected bandpass filter being responsive to said first filtered IF signal and generating a quadrature filtered output signal in response thereto;
said limiter amp stage being configured to receive said a IF signal and to generate a limiter amp output signal in response thereto;
said limiter amp output signal being passed to said quadrature detecting mixer first input; said quadrature detecting mixer second input being configured to receive said filtered limiter amp output signal from said third bandpass filter, said first quadrature detecting mixer generating a demodulated baseband signal in response thereto; and
said Limiting amp and said Mixer being integrated into a single integrated circuit.

23. The receiver demodulator of claim 22, said quadrature bandpass filter comprising a prefabricated fixed tuned filter.

24. The receiver demodulator of claim 22, said quadrature bandpass filter comprising a prefabricated ceramic filter having a fixed bandwidth approximately double the IF bandpass filter bandwidth.
